(19) United States
(12) Patent Application Publication
(10) Pub. No.: US 2022/0322018 A1
(43) Pub. Date: Oct. 6, 2022

(54) INTERCHANGEABLE HEARING DEVICE TRANSDUCER MODULE STORING TRANSDUCER CALIBRATION INFORMATION

(71) Applicant: Starkey Laboratories, Inc., Eden Prairie, MN (US)

(72) Inventor: Andrew Joseph Johnson, Eden Prairie, MN (US)

(21) Appl. No.: 17/634,884

(22) PCT Filed: Aug. 12, 2020
(86) PCT No.: PCT/US2020/045959

§ 371 Date: Feb. 11, 2022

Related U.S. Application Data
(60) Provisional application No. 62/885,930, filed on Aug. 13, 2019.

(51) Int. Cl. H04R 25/00

(52) U.S. Cl. CPC H04R 25/609; H04R 25/407; H04R 2225/0216

(57) ABSTRACT

An example of a hearing system for delivering sounds to a user may include a core module and an interchangeable transducer module. The core module may include an audio processing circuit configured to process audio signals representative of the sounds, a transducer interface circuit configured to provide the audio processing circuit with an interface to one or more transducers, and a case housing the audio processing circuit and the transducer interface circuit. The interchangeable transducer module may be configured to be detachably attached to the core module. The transducer module may include the transducer(s) and a transducer circuit configured to be communicatively coupled to the transducer interface circuit. The transducer circuit may include a memory circuit storing calibration information for the transducer(s). The calibration information may include one or more characteristics of each transducer determined during a calibration of that transducer.

### CLAIMS OF PRIORITY

This patent application claims the benefit of priority to U.S. Provisional Application Ser. No. 62/885,930, filed Aug. 13, 2019, which is incorporated by reference herein in its entirety.

### TECHNICAL FIELD

This document relates generally to hearing systems and more particularly to a hearing device with an interchangeable transducer module that includes at least one transducer and stores calibration data for that transducer.

### BACKGROUND

Hearing devices provide sound for listeners. Some examples of hearing devices include headsets, hearing aids, speakers, cochlear implants, bone conduction devices, and personal listening devices. A hearing aid provides amplification of sounds to compensate for hearing loss of a wearer by transmitting amplified sounds to an ear canal of the wearer. In various examples, a hearing aid is worn in and/or around the wearer's ear. The sounds may be detected from the wearer's environment using a microphone in the hearing aid. The hearing aid may allow the wearer to adjust the volume of the amplified sound for comfort of listening and/or speech intelligibility, among other things.

Settings of a hearing aid can be customized for the wearer in a fitting process. The extent to which the wearer can benefit from the hearing aid depends, among other things, hearing conditions the wearer and characteristics of the hearing aid that are known during the fitting process.

### SUMMARY

An example of a hearing system for delivering sounds to a user may include a core module and an interchangeable transducer module. The core module may include an audio processing circuit configured to process audio signals representative of the sounds, a transducer interface circuit configured to provide the audio processing circuit with an interface to one or more transducers, and a case housing the audio processing circuit and the transducer interface circuit. The interchangeable transducer module may be configured to be detachably attached to the core module. The transducer module may include the one or more transducers and a transducer circuit configured to be communicatively coupled to the transducer interface circuit. The transducer circuit may include a memory circuit storing calibration information for the one or more transducers. The calibration information may include one or more characteristics of each transducer of the one or more transducers determined during a calibration of that transducer.

An example of an apparatus is provided for use with a core module of a hearing aid to deliver sounds to a user having an ear. The core module may include an audio processing circuit for processing audio signals representative of the sounds, a transducer interface circuit providing the audio processing circuit with an interface to a transducer, and a case housing the audio processing circuit and the transducer interface circuit. The apparatus may include an interchangeable transducer module configured to be detachably attached to the core module. The transducer module may include the transducer and a transducer circuit configured to be communicatively coupled to the transducer interface circuit. The transducer circuit may include a memory circuit storing calibration information for the transducer. The calibration information including one or more characteristics of the transducer determined during a calibration of the transducer.

An example of a method for delivering sounds to a user is also provided. The method may include providing a hearing device configured to be worn by the user. The hearing device may include a core module and a transducer module. The core module may include an audio processing circuit configured to process audio signals representative of the sounds, a transducer interface circuit configured to provide the audio processing circuit with an interface to one or more transducers, and a case housing the audio processing circuit and the transducer interface circuit. The transducer module may be configured to be detachably attached to the core module and may include the one or more transducers and a transducer circuit configured to be communicatively coupled to the transducer interface circuit. The transducer circuit may include a memory circuit. The method may further include selecting each transducer of the one or more transducers by performing a calibration of that transducer and storing calibration information for each transducer obtained during the calibration of that transducer in the memory circuit. The calibration information may include one or more characteristics of the each transducer determined during the calibration of the each transducer.

This summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 is a block diagram illustrating an embodiment of a hearing system including a core module and a transducer module.

FIG. 2 is a block diagram illustrating an embodiment of a hearing system including a hearing device and a programming device.

FIG. 3 is an illustration of an embodiment of a receiver-in-canal (RIC) type hearing aid.

FIG. 4 is a block diagram illustrating an embodiment of portions of a circuit of a RIC type hearing aid, such as the hearing aid of FIG. 3.

FIG. 5 is a flow chart illustrating an embodiment of a method for storing calibration information for a transducer of a hearing device.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

This document discusses, among other things, a method and system for storing calibration data of transducers for hearing devices in interchangeable transducer modules. A hearing device can include at least one transducer, such as a receiver or a microphone. A calibration is performed to determine whether the transducer meets requirements for use with the hearing device. Calibration data, including data representing one or more characteristics of the transducer, are acquired during the calibration and can be useful in adjustment of the hearing device, for example when the settings of the hearing device are customized for a user (listener).

In one example, the hearing device is a hearing aid that includes a receiver (speaker). Hearing aid transducers (e.g., microphones and receivers) can have notoriously wide tolerances on sensitivity (e.g., ±3 dB). A calibration is performed during the hearing aid manufacturing process to determine whether each receiver meets requirements for being used with the hearing aid. The calibration process can use a stimulus such as a pure tone sinusoidal sound signal to evaluate the response of the receiver across a frequency range, and records the frequency response of the receiver. The calibration data including this frequency response information are used to determine whether the receiver is acceptable for use with the hearing aid. Such calibration data can be useful in adjusting the hearing aid for the user (hearing aid wearer). For example, it can be helpful to the audiologist fitting a hearing aid for a patient to know the frequency response of the receiver of that hearing aid. One way to provide the calibration data for a receiver for use after the calibration is to store the data in the hearing aid including that receiver. However, this approach is viable only when the transducer remains part of the hearing aid after the hearing aid manufacturing process. When the hearing aid includes an interchangeable part that includes the receiver, the hearing aid is likely to be paired with a receiver module after the manufacturing process, and the receiver module may be replaced one or more times through the lifetime of the hearing aid.

The present subject matter solves this problem by keeping calibration data of the receiver with the receiver when the receiver is in an interchangeable part of the hearing aid, thereby allowing for better fitting of the hearing aid for the patient. More generally, calibration data for a transducer used in a hearing deice are kept with the transducer when that transducer is an interchangeable part of the hearing device. According to the present subject matter, when a hearing device includes multiple modules and at least one transducer is in one of the modules, the calibration data acquired for that transducer are stored in the module that includes the transducer. In various embodiments, the transducer can include a receiver or a microphone, and the hearing aid can include one or more transducer modules each including at least a receiver, a microphone, or another type of transducer used in the hearing device. In some embodiments, a transducer module can include multiple transducers each being a receiver, a microphone, or another type of transducer used in the hearing device. In this document, a “transducer module” includes a module including at least one transducer (e.g., a receiver or microphone) for use as part of a hearing device (e.g., a hearing aid). In various embodiments, the transducer module is an interchangeable part of the hearing device.

While storing calibration data for a receiver in a receiver cable assembly of a receiver-in-canal (or RIC, also referred to as receiver-in-the-ear, or RITE) type hearing aid is specifically discussed as an example, the present subject matter is not limited to this application. Another example is to add a microphone for placement in the ear canal such that the receiver cable assembly further includes a microphone, and the acquisition and storage of the calibration data for the receiver as discussed in this document are repeated for the microphone. In various embodiments, calibration data for any transducer in a transducer module of a hearing device can be stored within the transducer module for use after the calibration of the transducer.

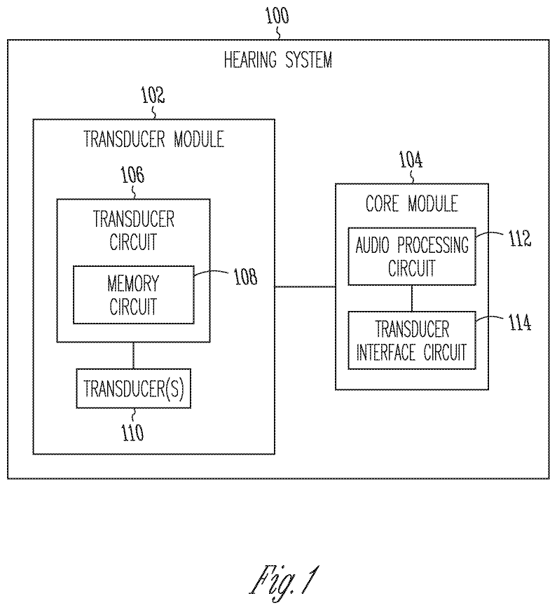

FIG. 1 is a block diagram illustrating an embodiment of a hearing system 100. Hearing system 100 can deliver sounds to a user (i.e., a listener) and includes a core module 104 and a transducer module 102. Core module 104 includes an audio processing circuit 112 that can process audio signals representative of the sounds and a transducer interface circuit 114 that can provide the audio processing circuit with an interface to one or more transducers 110 in transducer module 102. In various embodiments, core module 104 and transducer module 102 are housed in a case that can be worn by the user, such as in, over, or behind an ear of the user. Transducer module 102 can be interchangeable and detachably attached to core module 104. Transducer module 102 includes one or more transducers 110 and a transducer circuit 106 that can be communicatively coupled to transducer interface circuit 114. Transducer circuit 106 includes a memory circuit 108. Transducer(s) 100 can include one or more transducers each being calibrated and including one or more characteristics determined during the calibration. Calibration information for transducer(s) 110, which can include the one or more characteristics of each of the calibrated one or more transducers, can be stored in memory circuit 108. In various embodiments, the calibration information for a transducer of transducer(s) 110 is stored in memory circuit 110 upon the calibration of that transducer. In various other embodiments, the calibration information is stored in memory circuit 110 when all the transducers of transducer(s) 110 that need to be calibrated have been calibrated.

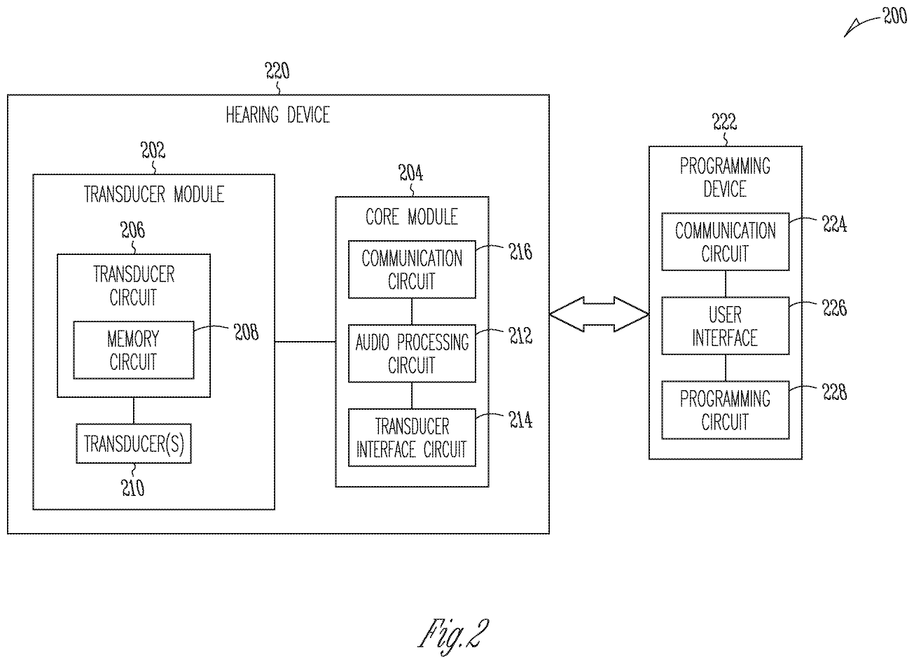

FIG. 2 is a block diagram illustrating an embodiment of a hearing system 200. System 200 represents an exemplary system in which system 100 can be implemented and includes a hearing device 220 that can deliver the sounds to the user and a programming device 222 that can be used (e.g., by an audiologist) to program hearing device 220.

Hearing device 220 can be worn by the user and includes a core module 204 and a transducer module 202. Core module 204 represents an example of core module 104 and includes a communication circuit 216, an audio processing circuit 212, and a transducer interface circuit 214. Communication circuit 216 can provide hearing device 220 with wireless communication capabilities, to allow for communication with programming device 222, for example. Audio processing circuit 212 can process audio signals representative of the sounds. In various embodiments, the audio signals can include signals received from one or more microphones and/or signals received by communication circuit 216. In various embodiments, audio processing circuit 212 can include a digital signal processor (DSP). Transducer interface circuit 214 provides audio processing circuit 212 with an interface to one or more transducers, such as transducer 210 of transducer module 202. In various embodiments, communication circuit 216, audio processing circuit 212, and transducer interface circuit 214 are housed in a case configured to be worn by the user, such as in, over, or behind an ear of the user.

Transducer module 202 represents an example of transducer module 102 and is an interchangeable transducer module that can be detachably attached to core module 204. Transducer module 202 includes one or more transducers 210 and a transducer circuit 206 that can be communicatively coupled to transducer interface circuit 214. Transducer circuit 206 includes a memory circuit 208. Transducer(s) 210 can include a receiver that can produce the sounds to be delivered to the user using the audio signals processed by audio processing circuit 212. Transducer(s) 210 can also include a microphone that can receive environmental sounds and produce audio signals (microphone signals) using the received environmental sounds. In various embodiments, transducer(s) 210 can include one or more receiver and/or one or more microphones. Transducer circuit 206 can include an integrated circuit (IC) and can be communicatively coupled to transducer interface circuit 214 via a wired or wireless link. Transducer circuit 206 includes a memory circuit 206 to store the calibration information for transducer(s) 210. The calibration information includes one or more characteristics of each transducer of transducer(s) 210 for which a calibration is performed to obtain the one or more characteristics. When transducer(s) 210 includes a receiver, a microphone, or a receiver and a microphone, the one or more characteristics of transducer(s) 210 can include the frequency response of each of the receiver and/or microphone measured during an acoustic calibration.

In various embodiments, transducer(s) 210 can include one or more receiver, one or more microphones, and one or more other transducers. Examples of the one or more other transducers include accelerometer, gyroscope, magnetometer, optical heart-rate sensor, blood glucose sensor, and/or temperature sensor. The accelerometer, gyroscope, and/or magnetometer, collectively known as an inertial measurement unit (IMU), can be used to track and react to movement of transducer module 202 and hence hearing device 220 when transducer module 202 is attached to hearing device 220. This can serve various purposes, such as activity tracking (e.g., step counting and detection of running or biking), safety monitoring (e.g., detecting when the user falls), head movement monitoring for sound enhancement, allowing for user control (e.g., by double tapping on the device), and/or being used as a simple on/off switch. The accelerometer, gyroscope, and magnetometer can each have three axes (e.g., x-axis accelerometer, y-axis accelerometer, etc.), so that together they can form a 9-axis IMU. Each axis can have multiple calibration factors, such as offset while at rest, movement scalars, or true-north calibration. When transducer(s) 210 includes an accelerometer, a gyroscope, and/or a magnetometer, the calibration information for transducer(s) 210 can include these calibration factors. The optical heart-rate sensor can use photoplethysmography to measure then user's heart rate. When transducer(s) 210 includes an optical heart-rate sensor, the calibration information for transducer(s) 210 can include physical dimensions that can help with filtering heart rate signals. The blood glucose sensors can monitor the user's blood glucose rate and can function similarly to the optical heart rate sensor. When transducer(s) 210 includes a blood glucose sensor, the calibration information for transducer(s) 210 can include the physical dimensions and possibly also information for better sensitivity and/or personalized details about the user (e.g., skin type and blood type, not sure). The temperature sensor can monitor the user's body temperature for health monitoring purposes (e.g., to notify the user if sickness is indicated or to track female ovulation cycles). When transducer(s) 210 includes a temperature sensor, the calibration information for can include a device-to-device calibration offset and possible some personalized calibration data about the user (which may be updated over time).

In various embodiments, the calibration information can be stored in memory circuit 208 in any suitable format as determined by those skilled in the art. For example, the calibration information as data stored in the memory circuit can be encrypted or unencrypted. The frequency response can be provided over linear or logarithmically spaced frequencies and can be an absolute response or normalized to a nominal response.

In various embodiments, the calibration information can be written into and read from memory circuit 208 using any suitable methods as determined by those skilled in the art. For example, the calibration information can be written into and read from memory circuit 208 via two or more electrical connections between transducer module 202 and core module 204 with one or several applicable communication protocols.

In various embodiments, a device identification code uniquely identifying each transducer module 202 or transducer 210 can also be stored in memory circuit 208 to allow for identification of that transducer module 202 or transducer 210, for example using programming device 222. Examples of the device identification code include a serial number assigned to transducer 210 by the manufacturer of the transducer and a serial number assigned to transducer module 202 by the manufacturer of hearing device 220.

Programming device 222 can include a communication circuit 224, a user interface 226, and a programming circuit 228. Communication circuit 224 provides for wireless communication between programming device 222 and hearing device 220. When the hearing device is being programmed (e.g., fitted for the user) using programming device, the calibration information can be received from hearing device 202 using communication circuit 224. User interface 226 can present the received calibration information, such as by displaying on a display screen. In various embodiments, the device identification code uniquely identifying transducer module 202 or transducer 210 can also be received from hearing device 202 using communication circuit 224 and presented using user interface 226. Programming circuit 228 can program hearing device 220. In various embodiments, the calibration information is used by programming 228 in the programming of hearing device 220. In various embodiments, programming device 222 can be a dedicated programmer or a generic device (e.g., a computer or smartphone) with a hearing device application such as a fitting program installed.

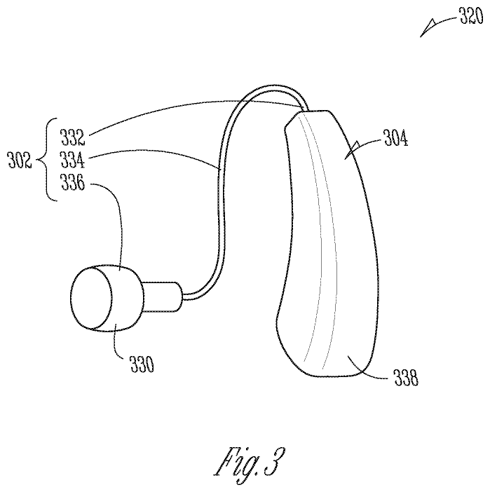

One type of hearing device that includes an interchangeable transducer module is a receiver-in-canal (or RIC, also referred to as receiver-in-the-ear, or RITE) type hearing aid. FIG. 3 is an illustration of an embodiment of a RIC type hearing aid 320, which represents an example of hearing device 220. Hearing aid 320 includes a core module 304 and a transducer module 302. Core module 304 can also be referred to as the hearing aid unit and include a main portion of hearing aid circuitry (e.g., including an audio processor) that is housed in a case 338. Case 338 of core module 304 is configured to be worn over or behind an ear of the user (i.e., the hearing aid wearer). Transducer module 302 can also be referred to as the receiver cable assembly, the RIC cable, or the RIC unit. The receiver of the RIC-type hearing aid is in receiver cable assembly 302 that can be detached from core module 304 and swapped for another receiver cable assembly. As illustrated in FIG. 3, receiver cable assembly 302 includes a proximal end 332 that can be detachably attached to core module 304, a distal end 336 including an earpiece 330 configured to be placed in the user's ear, and a cable 334 coupled between proximal end 332 and distal end 336. Earpiece 330 can include the receiver and circuitry of receiver cable assembly 302. Cable 334 includes wires electrically connecting the receiver and the circuitry to core module 304 when receiver cable assembly 302 is attached to core module 304.

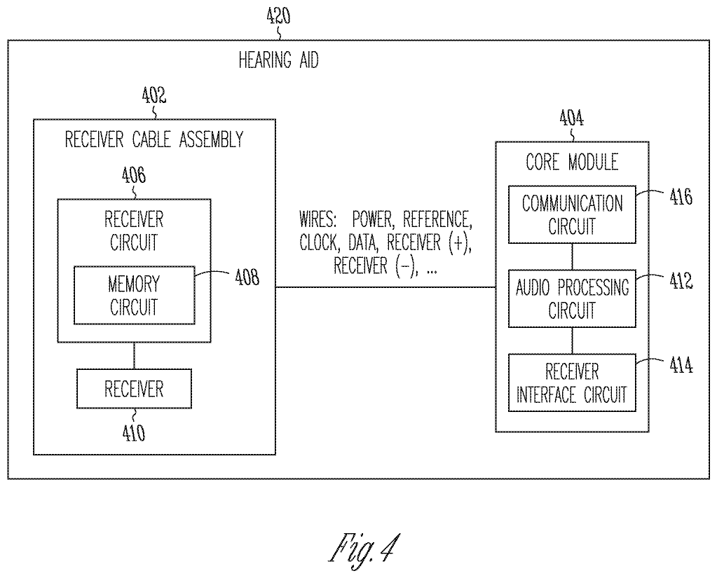

FIG. 4 is a block diagram illustrating an embodiment of portions of a circuit of a hearing aid 420. Hearing aid 420 as illustrated represents an example of a circuit of hearing aid 320 and includes a core module 404 and a receiver cable assembly 402.

Core module 404 represents an example of core module 204 and includes a communication circuit 416, an audio processing circuit 412, and a receiver driver circuit 414. A case such as case 330 houses communication circuit 416, audio processing circuit 412, and receiver driver circuit 414 so that core module 404 can be worn over or behind the user's ear. Communication circuit 416 can provide hearing device 420 with wireless communication capabilities, to allow for communication with another device, such as programming device 222 and/or another hearing aid (e.g., to be worn by the user's opposite ear). Audio processing circuit 412 can process audio signals representative of the sounds to be delivered to the user. In various embodiments, the audio signals can include signals received from one or more microphones and/or signals received by communication circuit 416. In various embodiments, audio processing circuit 412 can include a digital signal processor (DSP). Receiver driver circuit 414 represents an example of transducer interface circuit 214 and provides audio processing circuit 412 with an interface a receiver 410 of receiver cable assembly 402.

Receiver cable assembly 402 represents an example of transducer module 202 and includes receiver 410 and 1 receiver circuit 406. An acoustic calibration is performed for each individual receiver 410 to determine whether it meets the requirements for use in hearing aid 420. Because the acoustic calibration is performed for each individual receiver, the resultant calibration information acquired from each receiver is valid only for that receiver. Consequently, storing the calibration information in core module 404 become practically meaningless. Currently hearing aid manufacturers accept and work with the wide tolerance of receiver sensitivity. In other words, the acoustic calibration is performed to determine whether the receiver meets the requirements only. This problem can get worse with more transducers (e.g., one or more microphones) included in an interchangeable transducer module.

According to the present subject matter, to make the result of acoustic calibration for each receiver available for adjusting each RIC-type hearing aid, the calibration data are stored in the receiver cable assembly which includes the receiver. Thus, receiver circuit 406 includes a memory circuit 408 to store the calibration information, which can be useful, for example, in fitting hearing aid 420 for the user. This allows for a more accurate fitting (e.g., by allowing for a better prediction of the response of the hearing aid to sounds) when compared to accepting the wide tolerance of receiver sensitivity. In various embodiments, memory circuit 408 can include any memory device suitable for inclusion in receiver cable assembly 402 and for storing at least data representing the calibration information. An example of memory circuit 408 includes an electrically erasable programmable read-only memory (EEPROM) integrated circuit (IC). In various embodiments, the calibration information (e.g., frequency response) for receiver 410 is stored in memory circuit 408 upon completion of the calibration of receiver 410. The frequency response can include frequency response of voltage to acoustic pressure sensitivity and/or offsets of the frequency response from a predefined nominal frequency response. In various embodiments, memory circuit 408 also stores an identification code for transducer 410 and/or receiver cable assembly 402.

Receiver 410 and receiver circuit 406 can be housed in an earpiece, such as earpiece 330. Electrical connections between core module 404 and receiver cable assembly 402 are provided by wires, such as the wires in cable 334. As illustrated in FIG. 4, such wires may include connections for power, reference (ground), clock, data, and the receiver.

Hearing aid 420 can be fitted for the user using a fitting device such as programming device 222. In various embodiments, the fitting device can receive the calibration information for receiver 410 (e.g., via communication circuits 416 and 224) and presents the received calibration information using its user interface (e.g., user interfaced 226). The fitting device can include fitting software installed in a processor, such as the processor of programming circuit 228, to perform a fitting procedure that uses the calibration information.

While receiver 410 is illustrated in FIG. 4 and discussed as an example, receiver cable assembly can also include a microphone, and the acquisition, storage, and use of the calibration information for the receiver as discussed in this document can be repeated for the microphone. In various embodiments, the present subject matter can be applied to any transducer and interchangeable transducer module for hearing devices.

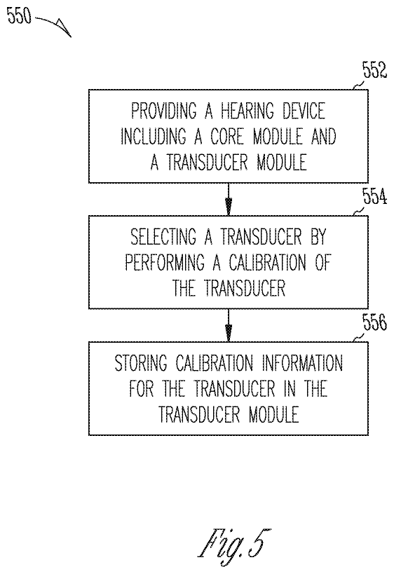

FIG. 5 is a flow chart illustrating an embodiment of a method 550 for storing calibration information for a transducer of a hearing device. In various embodiments, method 550 is performed with a hearing device including an interchangeable transducer module that includes a memory circuit, such as hearing system 100, hearing device 220, hearing aid 320, or hearing aid 420.

At 552, a hearing device including a core module and a transducer module is provided. The hearing device is configured to be worn by the user. The core module includes an audio processing circuit to process audio signals representative of the sounds, a transducer interface circuit to provide the audio processing circuit with an interface to a transducer, and a case housing the audio processing circuit and the transducer interface circuit. The transducer module can be detachably attached to the core module and includes the transducer and a transducer circuit that can be communicatively coupled to the transducer interface circuit. The transducer circuit includes a memory circuit. At 554, the transducer is selected by performing a calibration of the transducer. At 556, calibration information for the transducer obtained during the calibration of the transducer is stored in the memory circuit. The calibration information includes one or more characteristics of the transducer determined during the calibration of the transducer. Examples of the one or more characteristics of the transducer include a frequency response of the transducer when the transducer includes a receiver or a microphone.

In one embodiment, the transducer includes a receiver that can produce sounds using processed audio signals to be delivered to the user. The receiver is selected at 554, and the calibration information for the receiver is stored at 556. In one embodiment, the transducer module includes a microphone in addition to or in place of the receiver. The microphone is selected at 554, and the calibration information for the microphone is stored at 556.

In addition to storing the calibration information, a device identification code can also be stored in the memory circuit of the transducer module, the device identification code uniquely identifying the transducer module and/or the transducer in the transducer module.

One example of the hearing device for which method 550 can be performed is a RIC type hearing aid, such as hearing aid 320 or 420. The RIC type hearing aid includes an interchangeable receiver cable assembly as the transducer module that includes the memory circuit. Such a hearing aid can be fitted for the user using the calibration information stored in the memory circuit.

The present subject matter can be applied to hearing devices including, but not limited to, hearing aids for users suffering from substantial hearing loss, as well as PSAPs (personal sound amplification product) or hearable technology for users suffering from slight or no hearing loss, respectively.

Hearing devices typically include at least one enclosure or housing, a microphone, hearing device electronics including processing electronics, and a speaker or “receiver.” Hearing devices may include a power source, such as a battery. In various embodiments, the battery may be rechargeable. In various embodiments, multiple energy sources may be employed. It is understood that in various embodiments the microphone is optional. It is understood that in various embodiments the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing aids include a processor. In digital hearing aids with a processor, programmable gains may be employed to adjust the hearing aid output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application can be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Various types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein can be created by one of skill in the art without departing from the scope of the present subject matter.

Various embodiments of the present subject matter support wireless communications with a hearing device. In various embodiments the wireless communications can include standard or nonstandard communications. Some examples of standard wireless communications include, but not limited to, Bluetooth™, low energy Bluetooth, IEEE 802.11 (wireless LANs), 802.15 (WPANs), and 802.16 (WiMAX). Cellular communications may include, but not limited to, CDMA, GSM, ZigBee, and ultra-wideband (UWB) technologies. In various embodiments, the communications are radio frequency communications. In various embodiments the communications are optical communications, such as infrared communications. In various embodiments, the communications are inductive communications. In various embodiments, the communications are ultrasound communications. Although embodiments of the present system may be demonstrated as radio communication systems, it is possible that other forms of wireless communications can be used. It is understood that past and present standards can be used. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fibre-channel, Firewire or 1394, InfiniBand, or a native streaming interface. In various embodiments, such connections include all past and present link protocols. It is also contemplated that future versions of these protocols and new protocols may be employed without departing from the scope of the present subject matter.

In various embodiments, the present subject matter is used in hearing devices that are configured to communicate with mobile phones. In such embodiments, the hearing device may be operable to perform one or more of the following: answer incoming calls, hang up on calls, and/or provide two way telephone communications. In various embodiments, the present subject matter is used in hearing devices configured to communicate with packet-based devices. In various embodiments, the present subject matter includes hearing devices configured to communicate with streaming audio devices. In various embodiments, the present subject matter includes hearing devices configured to communicate with Wi-Fi devices. In various embodiments, the present subject matter includes hearing devices capable of being controlled by remote control devices.

It is further understood that different hearing devices may embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer.

The present subject matter may be employed in hearing devices, such as hearing aids, PSAPs, hearables, headsets, headphones, and similar hearing devices.

The present subject matter may be employed in hearing devices having additional sensors. Such sensors include, but are not limited to, magnetic field sensors, telecoils, temperature sensors, accelerometers and proximity sensors.

The present subject matter is demonstrated for hearing devices, including hearing aids, including but not limited to, behind-the-ear (BTE) and receiver-in-canal (RIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can be used in devices whether such devices are standard or custom fit and whether they provide an open or an occlusive design. It is understood that other hearing devices not expressly stated herein may be used in conjunction with the present subject matter.

Some non-limiting examples of the present subject matter are provided as follows.

In Example 1, a hearing system for delivering sounds to a user may include a core module and an interchangeable transducer module. The core module may include an audio processing circuit configured to process audio signals representative of the sounds, a transducer interface circuit configured to provide the audio processing circuit with an interface to one or more transducers, and a case housing the audio processing circuit and the transducer interface circuit. The interchangeable transducer module may be configured to be detachably attached to the core module. The transducer module may include the one or more transducers and a transducer circuit configured to be communicatively coupled to the transducer interface circuit. The transducer circuit may include a memory circuit storing calibration information for the one or more transducers. The calibration information may include one or more characteristics of each transducer of the one or more transducers determined during a calibration of that transducer.

In Example 2, the subject matter of Examples 1 may optionally be configured such that the memory circuit further stores a device identification code uniquely identifying the transducer module.

In Example 3, the subject matter of any one or any combination of Examples 1 and 2 may optionally be configured such that the one or more transducers include a receiver configured to produce the sounds using the processed audio signals.

In Example 4, the subject matter of Example 3 may optionally be configured such that the calibration information includes a frequency response of the receiver.

In Example 5, the subject matter of any one or any combination of Examples 1 to 4 may optionally be configured such that the one or more transducers include a microphone configured to receive environmental sounds and to produce the audio signals using the received environmental sounds.

In Example 6, the subject matter of any one or any combination of Examples 3 to 5 may optionally be configured to include a receiver-in-canal (RIC) type hearing aid including the core module and the transducer module, and configured such that the case is configured to be worn by the user behind or over an ear of the user, and the transducer module includes a receiver cable assembly including a proximal end configured to be detachably attached to the core module, a distal end including the receiver and configured to be placed in the ear, and a cable coupled between the proximal end and the distal end.

In Example 7, the subject matter of Example 6 may optionally be configured to further include a programming device including a communication circuit configured to receive the calibration information from the transducer module via the core module, a user interface configured to present the received calibration information, and a programming circuit configured to program the hearing aid and including a processor configured to execute a fitting program for fitting the hearing aid using the received calibration information.

In Example 8, the subject matter of any one or any combination of Examples 1 to 7 may optionally be configured such that the one or more transducers include an accelerometer.

In Example 9, the subject matter of any one or any combination of Examples 1 to 8 may optionally be configured such that the one or more transducers include a gyroscope.

In Example 10, the subject matter of any one or any combination of Examples 1 to 9 may optionally be configured such that the one or more transducers include a magnetometer.

In Example 11, the subject matter of any one or any combination of Examples 1 to 10 may optionally be configured such that the one or more transducers include an optical heart-rate sensor.

In Example 12, the subject matter of any one or any combination of Examples 1 to 11 may optionally be configured such that the one or more transducers include a blood glucose sensor.

In Example 13, the subject matter of any one or any combination of Examples 1 to 12 may optionally be configured such that the one or more transducers include a temperature sensor.

In Example 14, an apparatus is provided for use with a core module of a hearing aid to deliver sounds to a user having an ear. The core module may include an audio processing circuit for processing audio signals representative of the sounds, a transducer interface circuit providing the audio processing circuit with an interface to a transducer, and a case housing the audio processing circuit and the transducer interface circuit. The apparatus may include an interchangeable transducer module configured to be detachably attached to the core module. The transducer module may include the transducer and a transducer circuit configured to be communicatively coupled to the transducer interface circuit. The transducer circuit may include a memory circuit storing calibration information for the transducer. The calibration information including one or more characteristics of the transducer determined during a calibration of the transducer.

In Example 15, the subject matter of Example 14 may optionally be configured such that the transducer includes a receiver configured to produce the sounds using the processed audio signals.

In Example 16, the subject matter of Example 15 may optionally be configured such that the transducer module is configured to be a receiver cable assembly for a receiver-in-canal (RIC) type hearing aid. The receiver cable assembly includes a proximal end configured to be detachably attached to the core module of the hearing aid, a distal end including the receiver and configured to be placed in an ear of the user, and a cable coupled between the proximal end and the distal end.

In Example 17, the subject matter of any one or any combination of Examples 15 and 16 may optionally be configured such that the transducer module further includes a microphone configured to receive environmental sounds and to produce the audio signals using the received environmental sounds, and the memory circuit further stores calibration information for the microphone.

In Example 18, the subject matter of any one or any combination of Examples 14 to 17 may optionally be configured such that the memory circuit further stores a device identification code uniquely identifying the transducer module.

In Example 19, a method for delivering sounds to a user is provided. The method may include providing a hearing device configured to be worn by the user. The hearing device may include a core module and a transducer module. The core module may include an audio processing circuit configured to process audio signals representative of the sounds, a transducer interface circuit configured to provide the audio processing circuit with an interface to one or more transducers, and a case housing the audio processing circuit and the transducer interface circuit. The transducer module may be configured to be detachably attached to the core module and may include the one or more transducers and a transducer circuit configured to be communicatively coupled to the transducer interface circuit. The transducer circuit may include a memory circuit. The method may further include selecting each transducer of the one or more transducers by performing a calibration of that transducer and storing calibration information for each transducer obtained during the calibration of that transducer in the memory circuit. The calibration information may include one or more characteristics of the each transducer determined during the calibration of the each transducer.

In Example 20, the subject matter of providing the hearing device as found in Example 19 may optionally include providing a receiver of the one or more transducers, the subject matter of selecting each transducer by performing the calibration of that transducer as found in Example 19 may optionally include selecting the receiver by performing a calibration of the receiver, and the subject matter of storing the calibration information for each transducer as found in Example 19 may optionally include storing the calibration information for the receiver. The receiver is configured to produce the sounds using the processed audio signals.

In Example 21, the subject matter of Example 20 may optionally further include determining a frequency response of the receiver to include in the calibration information during the calibration of the receiver.

In Example 22, the subject matter of providing the hearing device as found in any one or any combination of Examples 19 and 21 may optionally include providing a microphone of the one or more transducers, the subject matter of selecting each transducer by performing the calibration of that transducer as found in any one or any combination of Examples 19 and 20 may optionally include selecting the microphone by performing a calibration of the microphone, and the subject matter of storing the calibration information for each transducer as found in any one or any combination of Examples 19 and 20 may optionally include storing the calibration information for the microphone. The microphone is configured to receive environmental sounds and to produce the audio signals using the received environmental sounds.

In Example 23, the subject matter of Example 22 may optionally further include determining a frequency response of the microphone to include in the calibration information during the calibration of the receiver.

In Example 24, the subject matter of any one or any combination of Examples 19 to 23 may optionally further include storing a device identification code in the memory circuit of the transducer module. The device identification code uniquely identifies the transducer module.

In Example 25, the subject matter of providing the hearing device as found in any one or any combination of Examples 20 to 24 may optionally include providing a receiver-in-canal (RIC) type hearing aid including the core module and the transducer module, and the subject matter of any one or any combination of Examples 20 to 24 may optionally further include configuring the case for being worn by the user behind or over an ear of the user and configuring the transducer module to be a receiver cable assembly including a proximal end configured to be detachably attached to the core module, a distal end including the receiver and the transducer circuit and configured to be placed in the ear, and a cable coupled between the proximal end and the distal end.

In Example 26, the subject matter of Example 25 may optionally further include fitting the hearing device for the user using the calibration information stored in the memory circuit of the receiver cable assembly.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing system for delivering sounds to a user having an ear, comprising:
a core module including an audio processing circuit configured to process audio signals representative of the sounds, a transducer interface circuit configured to provide the audio processing circuit with an interface to one or more transducers, and a case housing the audio processing circuit and the transducer interface circuit; and
an interchangeable transducer module configured to be detachably attached to the core module, the transducer module including the one or more transducers and a transducer circuit configured to be communicatively coupled to the transducer interface circuit, the transducer circuit including a memory circuit storing calibration information for the one or more transducers, the calibration information including one or more characteristics of each transducer of the one or more transducers determined during a calibration of the each transducer.

2. The hearing system of claim 1, wherein the one or more transducers comprises at least one of a receiver, a microphone, an accelerometer, a gyroscope, a magnetometer, an optical heart-rate sensor, a blood glucose sensor, or a temperature sensor.

3. The hearing system of claim 1, wherein the memory circuit further stores a device identification code uniquely identifying the transducer module.

4. The hearing system of claim 1, wherein the one or more transducers comprise a receiver configured to produce the sounds using the processed audio signals.

5. The hearing system of claim 4, wherein the calibration information comprises a frequency response of the receiver.

6. The hearing system of claim 4, wherein the one or more transducers further comprise a microphone configured to receive environmental sounds and to produce the audio signals using the received environmental sounds.

7. The hearing system of claim 4, comprising a receiver-in-canal (RIC) type hearing aid including the core module and the transducer module, and wherein the case is configured to be worn by the user behind or over the ear, and the transducer module comprises a receiver cable assembly including a proximal end configured to be detachably attached to the core module, a distal end including the receiver and configured to be placed in the ear, and a cable coupled between the proximal end and the distal end.

8. The hearing system of claim 7, further comprising a programming device including:
a communication circuit configured to receive the calibration information from the transducer module via the core module;
a user interface configured to present the received calibration information;
a programming circuit configured to program the hearing aid and including a processor configured to execute a fitting program for fitting the hearing aid using the received calibration information.

9. An apparatus for use with a core module of a hearing aid to deliver sounds to a user having an ear, the core module including an audio processing circuit for processing audio signals representative of the sounds, a transducer interface circuit providing the audio processing circuit with an interface to a transducer, and a case housing the audio processing circuit and the transducer interface circuit, the apparatus comprising:
an interchangeable transducer module configured to be detachably attached to the core module, the transducer module including:
the transducer; and
a transducer circuit configured to be communicatively coupled to the transducer interface circuit, the transducer circuit including a memory circuit storing calibration information for the transducer, the calibration information including one or more characteristics of the transducer determined during a calibration of the transducer.

10. The apparatus of claim 9, wherein the transducer comprises a receiver configured to produce the sounds using the processed audio signals.

11. The apparatus of claim 10, wherein the transducer module is configured to be a receiver cable assembly for a receiver-in-canal (RIC) type hearing aid, the receiver cable assembly including:
a proximal end configured to be detachably attached to the core module of the hearing aid;
a distal end including the receiver and configured to be placed in the ear;
and a cable coupled between the proximal end and the distal end.

12. The apparatus of claim 11, wherein the transducer module further comprises a microphone configured to receive environmental sounds and to produce the audio signals using the received environmental sounds, and the memory circuit further stores calibration information for the microphone.

13. The apparatus of claim 11, wherein the memory circuit further stores a device identification code uniquely identifying the transducer module.

14. A method for delivering sounds to a user having an ear, comprising:
providing a hearing device configured to be worn by the user, the hearing device including a core module and a transducer module, the core module including an audio processing circuit configured to process audio signals representative of the sounds, a transducer interface circuit configured to provide the audio processing circuit with an interface to one or more transducers, and a case housing the audio processing circuit and the transducer interface circuit, the transducer module configured to be detachably attached to the core module and including the one or more transducers and a transducer circuit configured to be communicatively coupled to the transducer interface circuit, the transducer circuit including a memory circuit;
selecting each transducer of the one or more transducers by performing a calibration of the each transducer; and
storing calibration information for the each transducer obtained during the calibration of the each transducer in the memory circuit, the calibration information including one or more characteristics of the each transducer determined during the calibration of the each transducer.

15. The method of claim 14, wherein providing the hearing device comprises providing a receiver of the one or more transducers, selecting the each transducer by performing the calibration of the each transducer comprises selecting the receiver by performing a calibration of the receiver, and storing the calibration information for the each transducer comprises storing the calibration information for the receiver, the receiver configured to produce the sounds using the processed audio signals.

16. The method of claim 15, wherein providing the hearing device further comprises providing a microphone of the one or more transducers, selecting the each transducer by performing the calibration of the each transducer comprises selecting the microphone by performing a calibration of the microphone, and storing the calibration information for the each transducer comprises storing the calibration information for the microphone, the microphone configured to receive environmental sounds and to produce the audio signals using the received environmental sounds.

17. The method of claim 15, further comprising storing a device identification code in the memory circuit of the transducer module, the device identification code uniquely identifying the transducer module.

18. The method of claim 15, further comprising determining a frequency response of the receiver to include in the calibration information during the calibration of the receiver.

19. The method of claim 18, wherein providing the hearing device comprises providing a receiver-in-canal (RIC) type hearing aid including the core module and the transducer module, and further comprising:
configuring the case for being worn by the user behind or over the ear;
and
configuring the transducer module to be a receiver cable assembly including a proximal end configured to be detachably attached to the core module, a distal end including the receiver and the transducer circuit and configured to be placed in the ear, and a cable coupled between the proximal end and the distal end.

20. The method claim 19, further comprising fitting the hearing aid for the user using the calibration information stored in the memory circuit of the receiver cable assembly.
